(19) United States
(12) Patent Application Publication
(10) Pub. No.: US 2005/0252328 A1
(43) Pub. Date: Nov. 17, 2005

(54) Helical gear assembly

(75) Inventors: Charles W. Shattuck, West Goshen, CT (US); Richard F. Murphy, Torrington, CT (US)

Correspondence Address: MICHAEL BEST & FRIEDRICH, LLP, 100 E WISCONSIN AVENUE, MILWAUKEE, WI, 53202, US

(73) Assignee: Timken US Corporation, Torrington, CT (US)

(21) Appl. No.: 11/125,454

(22) Filed: May 10, 2005

Related U.S. Application Data
(60) Provisional application No. 60/569,945, filed on May 11, 2004.

(51) Int. Cl. F16H 1/00

(52) U.S. Cl. 74/431

(57) ABSTRACT

A gear assembly includes a gear having a cylindrical inner bore. A sleeve having a convex inner bearing surface is positioned within the gear bore and a shaft is positioned within the sleeve inner bearing surface. A plurality of rollers are positioned between the shaft and the sleeve convex inner bearing surface. The sleeve may further include a pair of opposed radially inwardly extending flanges configured to axially retain the rollers within the sleeve.

### RELATED APPLICATIONS

This application claims priority to U.S. Provisional Patent Application Ser. No. 60/569,945 filed May 11, 2004, the entire contents of which are hereby incorporated by reference.

### BACKGROUND

The present invention relates to gears used to transmit torque. More specifically, the present invention relates to helical gears that rotate on anti-friction needle or roller bearings such as the planet gears used in automotive automatic transmissions.

FIG. 1 shows a representative helical gear assembly 1 comprising a helical gear 2, a roller bearing 3 including a complement of rollers 4, and inner shaft 5. Typically the helical gears produce an overturning load on the roller bearing 3 resulting in the ends of the rollers 4 predominately carrying the radial load. FIG. 2 is a cross section view of the assembly in FIG. 1 showing the misalignment of the rollers 4 resulting from the overturning load. The misalignment is exaggerated for clarity. As can be seen, the rollers 4 are only contacting the shaft 5 at their ends, providing a very small contact area 6. The end loading of the rollers 4 with a minimum contact area 6 can result in premature failure. Normal failure mode is surface fatigue failure of the shaft 5.

FIG. 3 shows a cross section view of a prior art attempt to overcome the roller end loading. By making the shaft 5′ for the bearing a crowned shape, which is also exaggerated in the figure, the length of the roller 4 to shaft 5′ contact area 6a is increased. This approach improves the life of the shaft surface, however, with the ever-increasing requirements for greater power and durability, even this increase in life is sometimes not sufficient.

FIG. 4 shows another prior art attempt to overcome the roller end loading by creating an optimum convex profile in the bore of the gear 2′. This allows the length of the roller 4 to shaft 5 contact area 6b to be maximized. However, this method can be difficult to control using the typical manufacturing techniques for gears, specifically, grinding and honing cannot easily or consistently produce the required profiled shapes. In the prior art, the gear bore acts as the outer raceway for the roller complement. There are some treatments for gears, such as shot peening, that would improve the gear life but adversely affect the bearing raceway life. These treatments either cannot be done or need to be done selectively.

### SUMMARY

The present invention provides a gear assembly comprising a gear having a cylindrical inner bore. A sleeve having a convex inner bearing surface is positioned within the gear bore. A shaft is positioned within the sleeve inner bearing surface and a plurality of rollers are positioned between the shaft and the sleeve convex inner bearing surface. The sleeve may further include a pair of opposed radially inwardly extending flanges configured to axially retain the rollers within the sleeve. The gear can be a helical gear.

Other aspects of the invention will become apparent by consideration of the detailed description and accompanying drawings.

### BRIEF DESCRIPTION OF THE DRAWINGS

FIG. 1 is an isometric view of a representative prior art helical gear assembly.

FIG. 2 is a cross sectional view of the helical gear assembly along line 2-2 in FIG. 1.

FIG. 3 is a cross sectional view similar to FIG. 2 showing the shaft formed with a crowned surface.

FIG. 4 is a cross sectional view similar to FIG. 2 showing the gear bore formed with a convex profile.

FIG. 5 is a cross sectional view showing the helical gear assembly that is a first embodiment of the present invention.

FIG. 6 is a cross sectional view showing the helical gear assembly that is a second embodiment of the present invention.

FIG. 7 is a cross sectional view similar to FIG. 2 showing the prior art helical gear assembly positioned within a washer assembly.

FIG. 8 is a cross sectional view showing the helical gear assembly of FIG. 6 installed and retained about the shaft with friction reducing washers.

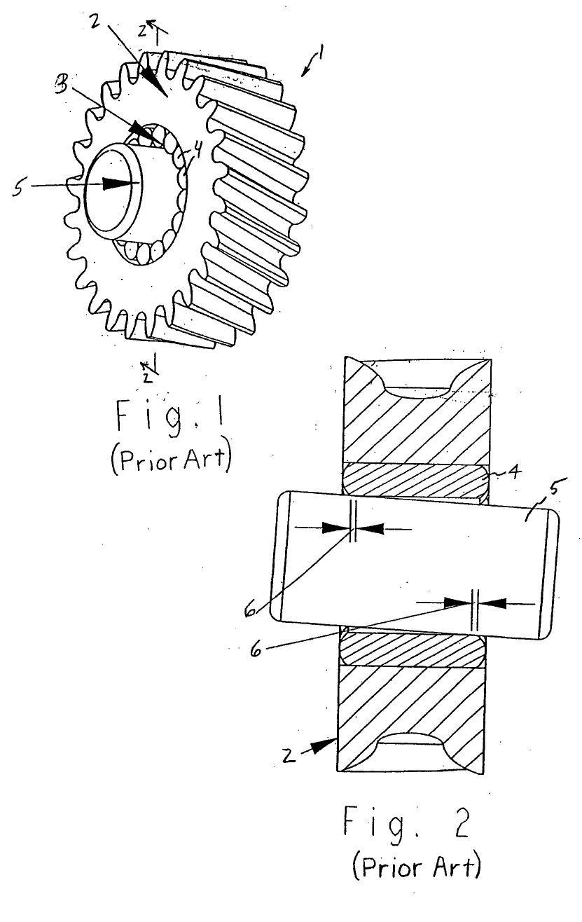

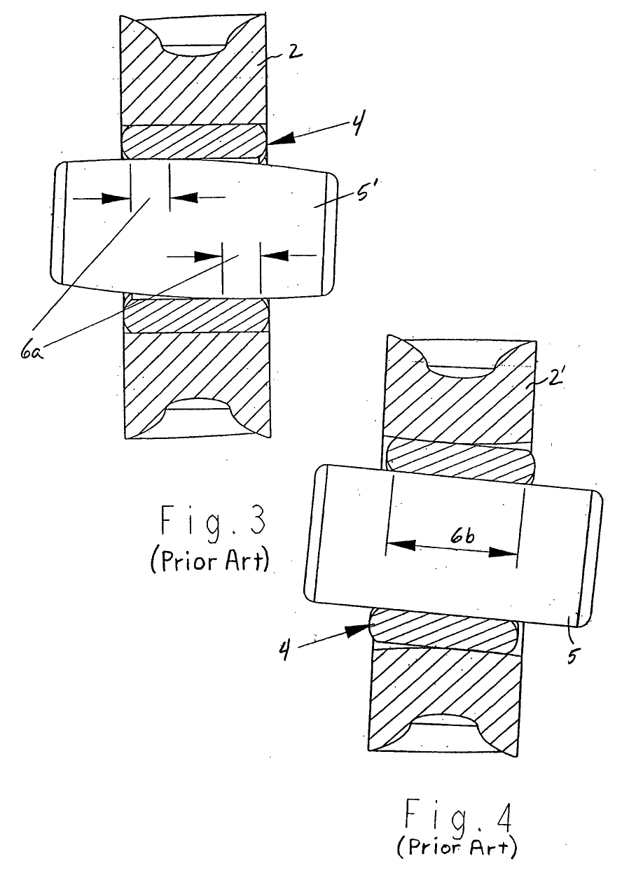

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

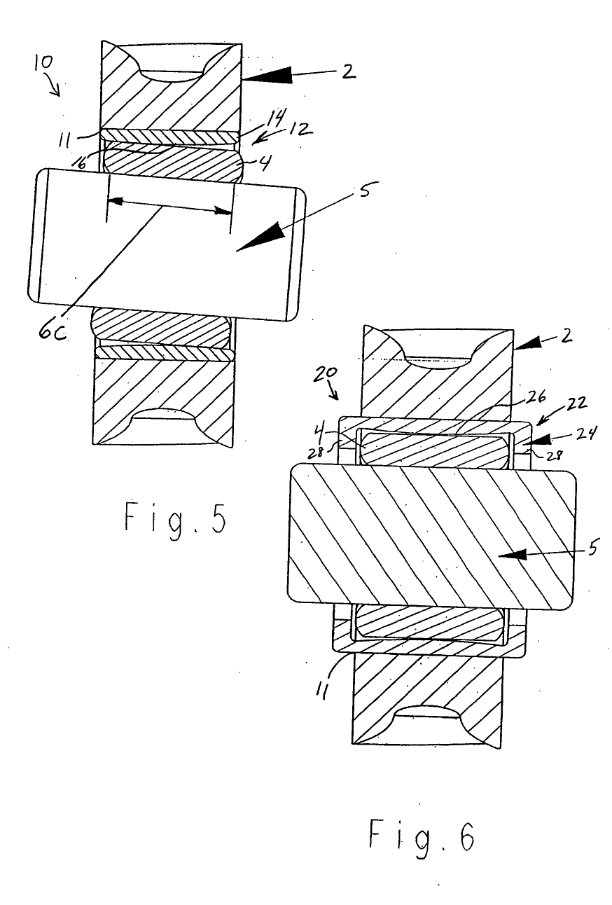

Referring to FIG. 5 a helical gear assembly 10 that is a first embodiment of the present invention is shown. The helical gear assembly 10 includes a helical gear 2, a bearing assembly 12 and an inner shaft 5. While a helical gear 2 is illustrated, the invention can also be practiced with other types of gears. The gear 2 has an inner gear bore 11 configured to receive the bearing assembly 12 and the inner shaft 5. The inner gear bore 11 is formed with a substantially cylindrical, non-profiled inner surface. The bearing assembly 12 includes a plurality of rollers 4 positioned within a profiled sleeve 14. The profiled sleeve 14 includes a convex inner bearing surface 16. The convex surface 16 allows the rollers 4 to tilt, thereby maximizing the contact area 6c between the rollers 4 and the shaft 5. As seen in FIG. 5, the contact area 6c between the rollers 4 and the shaft 5 extends substantially the entire axial length of the rollers 4.

The profiled sleeve 14 is preferably manufactured using a drawing process. Through the use of proper tooling, the drawing process allows the convex surface 16 to be effectively formed in the sleeve 14. The formed profile sleeve 12 is press fit, or otherwise secured, within the bore 11 of the gear 2. The rollers 4 may then be loaded within the sleeve 12 in a known manner, for example, by utilizing an automated roller loading machine.

In applications in which the helical gear assembly 10 is subjected to heavy loads, the sleeve 12 is preferably drawn from a high carbon material that can be heat treated and through hardened to a hardness greater than 58 HRc or equivalent. The high carbon steel, when drawn, produces a surface finish that does not require the typical honing process for the gear bore. Furthermore, the profiled sleeve 12 and the helical gear 2 may be formed from different materials if desired. Furthermore, the sleeve can be optimized for bearing raceway requirements through the use of coatings or special heat treat processes without having to apply these processes to the entire gear.

Referring to FIG. 6, a helical gear assembly 20 that is a second embodiment of the present invention is shown. The helical gear assembly 20 is similar to the previous embodiment and includes a helical gear 2, a bearing assembly 22 and an inner shaft 5. The gear 2 has an inner gear bore 11 configured to receive the bearing assembly 12 and the inner shaft 5. The inner gear bore 11 is formed with a cylindrical, non-profiled inner surface. The bearing assembly 22 includes a plurality of rollers 4 positioned within a profiled sleeve 24. As in the previous embodiment, the profiled sleeve 24 includes a convex inner bearing surface 26 that allows the rollers 4 to tilt, thereby maximizing the contact area between the rollers 4 and the shaft 5. Additionally, the sleeve 24 of the present embodiment further comprises a radial flange 28 extending from each end bearing surface 26. The opposed end flanges 28 form a channel shape for the rollers 4. The gear 2, sleeve 24 and bearing rollers 4 are preferably preassembled prior to installation in to the end application, for example, in a transmission, with the end flanges 28 axially retaining the rollers 4. The rollers 4 can be held in the sleeve 24 using any known retention method such as a plug, a retaining cage or the use of a heavy grease. Such preassembly eliminates the need for the end assembler to load all of the rollers 4 at the time of assembly. When the rollers are to be assembled by the end assembler, at times the design of the rollers needs to be optimized for assembly by insuring the rollers can “keystone” or “skew lock”, which are common practices for those skilled in the art. This can result in performance compromises for the sake of assembly purposes. By utilizing the pre-assembled gear with flanged sleeve, these design compromises are eliminated.

The end flanges 28 also supply an axial thrust surface for the rollers 4. Typical use of these helical gears requires thrust washers be assembled on each side of the gear 2. FIG. 7 shows a typical gear and washer arrangement as previously used. Steel washers 8 act against the ends of the rollers 4, and friction reducing washers 9, normally a non-steel washer, bronze for example, are positioned next to the steel washers 8 to act as a bearing surface.

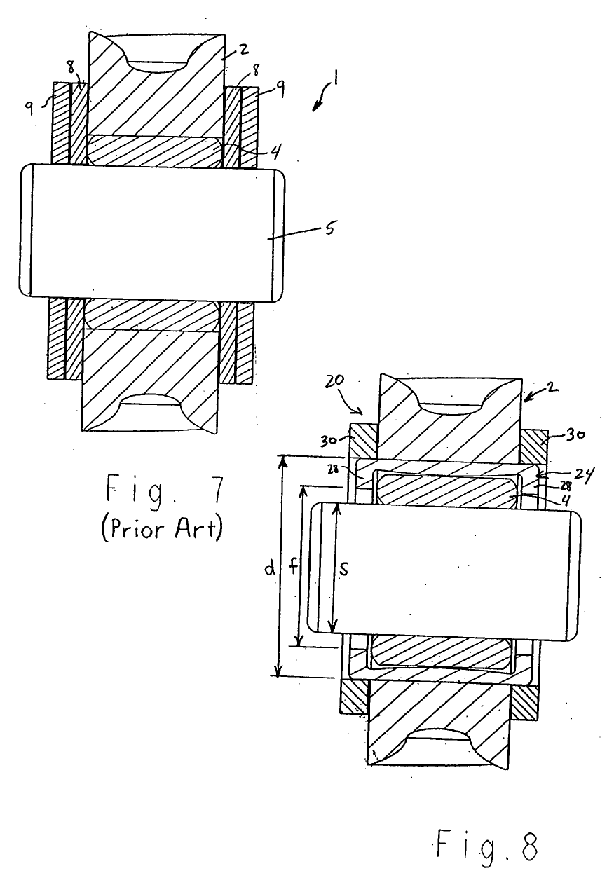

FIG. 8 shows how the helical gear assembly 20 of the current embodiment can reduce the overall length of the gear and washer assembly. The end flanges 28 of the sleeve 24 provide a thrust surface for the rollers 4, similar to the steel washers 8 shown in FIG. 7. A friction reducing washer 30, for example, a bronze washer similar to washer 9 of FIG. 7, having an inner diameter approximately equal to the outside diameter d of the sleeve 24, is provided on each end of the sleeve 24 that extends outside the gear 2 width. As a result, the thrust and bearing function are achieved in a more compact assembly.

Additionally, the inner flange bore diameter f need only be small enough to retain the rollers 4 in the axial direction; typically at about the pitch diameter of the roller complement. The remaining clearance between the flange bore inner diameter f and the shaft outer diameter s provides improved lubricant access to the bearing compared with the conventional assembly shown in FIG. 7 which has little clearance between the washers 8 and 9 and the shaft 5.

Various features of the invention are set forth in the following claims.

1. A gear assembly comprising:
a gear having a substantially cylindrical inner bore;
a sleeve having a convex inner bearing surface positioned within the bore;
a shaft positioned within the inner bearing surface; and
a plurality of rollers positioned between the shaft and the convex inner bearing surface.

2. The gear assembly of claim 1, wherein the sleeve further comprises a pair of opposed radially inwardly extending flanges configured to axially retain the rollers within the sleeve.

3. The gear assembly of claim 2, wherein the radially inwardly extending flanges are sized to provide an annular gap between the flanges and the shaft to facilitate insertion of lubricant into the sleeve.

4. The gear assembly of claim 1, wherein each of the plurality of rollers contacts the shaft at a contact area extending substantially the entire axial length of the rollers.

5. The gear assembly of claim 1, further comprising a washer having an inside diameter sized such that the washer can be positioned on an outer diameter of the sleeve.

6. The gear assembly of claim 1, wherein the sleeve is made from a drawn, high carbon material.

7. The gear assembly of claim 1, wherein the sleeve has a hardness greater than 58 HRc.

8. The gear assembly of claim 1, wherein the inner bore of the gear is not honed.

9. The gear assembly of claim 1, wherein the gear and the sleeve are made from different materials.

10. The gear assembly of claim 1, wherein the sleeve is press fit into the inner bore of the gear.

11. The gear assembly of claim 1, wherein the gear is a helical gear.

12. A gear assembly comprising:
a gear having a substantially cylindrical inner bore;
a sleeve having a convex inner bearing surface positioned within the bore;
a shaft positioned within the inner bearing surface;
a plurality of rollers positioned between the shaft and the convex inner bearing surface; and
wherein the sleeve further comprises a pair of opposed radially inwardly extending flanges configured to axially retain the rollers within the sleeve.

13. The gear assembly of claim 12, wherein the radially inwardly extending flanges are sized to provide an annular gap between the flanges and the shaft to facilitate insertion of lubricant into the sleeve.

14. The gear assembly of claim 12, wherein each of the plurality of rollers contacts the shaft at a contact area extending substantially the entire axial length of the rollers.

15. The gear assembly of claim 12, further comprising a washer having an inside diameter sized such that the washer can be positioned on an outer diameter of the sleeve.

16. The gear assembly of claim 12, wherein the sleeve is made from a drawn, high carbon material.

17. The gear assembly of claim 12, wherein the sleeve has a hardness greater than 58 HRc.

18. The gear assembly of claim 12, wherein the inner bore of the gear is not honed.

19. The gear assembly of claim 12, wherein the gear and the sleeve are made from different materials.

20. The gear assembly of claim 12, wherein the sleeve is press fit into the inner-bore of the gear.

21. The gear assembly of claim 12, wherein the gear is a helical gear.
